(19) United States
(12) Patent Application Publication
(10) Pub. No.: US 2010/0150219 A1
(43) Pub. Date: Jun. 17, 2010

(54) SAMPLING DEVICE AND METHOD IN WIRELESS COMMUNICATION SYSTEM

(76) Inventors: Mi-Kyung Oh, Gyeongsangbuk-do (KR); Joo Ho Park, Daejeon (KR); Jung-yeol Oh, Daejeon (KR); Min Su Kil, Chungcheongnam-do (KR); Jae Young Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/549,864

(22) Filed: Aug. 28, 2009

(30) Foreign Application Priority Data
Dec. 11, 2008 (KR) 10-2008-0126112
Mar. 30, 2009 (KR) 10-2009-0027097

(51) Int. Cl. H04B 17/00

(52) U.S. Cl. 375/228

(57) ABSTRACT

The exemplary embodiment of present invention provides a sampling device and method in a wireless communication system that is capable of precisely measuring a distance by combining data blocks passing through at least two delay paths and performing sampling thereon.

To this end, the sampling device includes: a delayer that delays received signals in a block unit; a delay path selector that selects any one of a plurality of delay paths to control the delayer to apply the selected delay path to each block; a sampler that performs sampling for each block delayed by the delayer; a signal processor that combines at least two sampling blocks sampled by the sampler; and a timing tracker that tracks reception timing of the combined signal, wherein the delayer includes at least two selectable delay paths.

### CROSS-REFERENCE TO RELATED APPLICATION

This application claims priority to and the benefit of Korean Patent Application Nos. 10-2008-0126112 and 10-2009-0027097 filed in the Korean Intellectual Property Office on Dec. 11, 2008 and Mar. 30, 2009, the entire contents of which are incorporated herein by reference.

### BACKGROUND OF THE INVENTION

(a) Field of the Invention

The exemplary embodiment of the present invention relates to a sampling device and method in a wireless communication system.

(b) Description of the Related Art

Recently, a wireless technology of an impulse scheme is increasingly gaining attention as a promising technology such that it is being adopted as a physical layer technology of IEEE 802.15.4a that is an international standard of Wireless Personal Area Network (WPAN) for low speed position recognition, due to its low power consumption and unique distance estimation capability.

IEEE 802.15.4a has adopted the two way ranging (TWR) technique as a method for measuring a distance between nodes on a system that does not need to match network synchronization between nodes.

In other words, in an asynchronous system, since all nodes are operated having time information, the distance between the nodes can be estimated through bidirectional transmission.

In detail, a transmission node stores time information to be transmitted while transmitting signals at a defined time.

If a reception node receives the signals after propagation time, it estimates time information upon receiving and retransmits the signals after a predetermined response time elapses therefrom.

Then, the transmission node receives the signals and stores time information.

The transmission node calculates time of arrival (TOA) between two nodes by using time information at first transmission, time information at final reception timing, and response time information.

Further, the distance between two nodes is estimated by multiplying the calculated time of arrival by propagation speed.

IEEE 802.15.4a uses a first pulse included in a PHY header of a packet for impulse as a transmitting/receiving reference signal for measuring a distance, wherein the reference pulse is named RMARKER.

On the other hand, in order to accurately measure the distance, the transmission and reception timing of RMARKER should be matched. However, the timing obtained in a preamble period may be generally different from the reception timing of RMARKER due to clock mismatch between a transmission period and a reception period.

Therefore, in order to track the accurate timing, a timing tracker using “PHY Tracking Loop” is essential.

In other words, when the timing tracker included in a node of a receiving end compensates for clock offset, if there are receiving signals sampled at high speed, the timing tracker can be precisely updated such that an error of the clock offset can be reduced.

Further, resolution of the timing tracker is associated with sampling speed of an analog-to-digital converter (ADC).

In other words, IEEE 802.15.4a IR-UWB system uses a pulse of about 2 nsec and needs a sampling device of at least 1 Gsps so as not to lose information in the sampling process of the pulse.

However, since the sampling device of 1 Gsps tracks timing with resolution of 1 nsec, an error of 1 nsec may occur, which appears as a distance error of 30cm in a distance measurer.

If the sampling is insufficient, it is possible to miss the non-continuous pulse signals in a time domain.

Therefore, the sampling is performed at high speed, and thus the timing can be accurately tracked at high resolution.

However, an analog-to-digital converter that is capable of performing the high-speed sampling is very expensive and has high power consumption, such that it is difficult to adopt it in the system.

Moreover, even though the sampling is performed at high speed, it is difficult to implement a precise timing tracker due to structural limitations in processing digital signals in the related art.

The above information disclosed in this Background section is only for enhancement of understanding of the background of the invention and therefore it may contain information that does not form the prior art that is already known in this country to a person of ordinary skill in the art.

### SUMMARY OF THE INVENTION

The exemplary embodiment of the present invention is to provide a distance measuring unit that is capable of precisely extracting timing information while using a sampling device having low complexity for measuring a distance between asynchronous nodes.

In order to achieve the above object, an exemplary embodiment of the present invention provides a sampling device in a wireless communication system, including: a delayer that delays received signals in a block unit; a delay path selector that selects any one of a plurality of delay paths to control the delayer to apply the selected delay path to each block; a sampler that performs sampling for each block delayed by the delayer; a signal processor that combines at least two sampling blocks sampled by the sampler; and a timing tracker that tracks reception timing of the combined signal.

Herein, each of the plurality of delay paths can be independently implemented with respect to predetermined delay values, and can be implemented in a manner that disposes delay paths having the longest delay values at a predetermined interval and then connects delay paths having smaller delay values by a tab at the middle of the delay paths disposed at the predetermined interval.

The delay path selector uses a predetermined selection pattern to control the delay path selection of the delayer, or may control the delay path selection of the delayer according to external selection control signals.

The timing tracker may control timing tracking granularity in consideration of the delay paths selected by the delayer or control to perform timing tracking update in the combined sampling block unit when oversampling is performed by a sampling combination of the signal processor.

Further, the timing tracker may determine a performance position of the timing tracking update by comparing generation positions of the oversampling by using the delay values of the delayer as correction parameters when the oversampling is performed by the sampling combination of the signal processor.

The signal processor performs N-times oversampling while combining the sampling block, and the delay path selector controls the delayer to select the delay paths having delay values closest to a 1/N sampling period when the N-times oversampling is performed.

Another embodiment of the present invention provides a sampling method in a wireless communication system that allows a receiver to sample signals, including: delaying the received signal in a block unit when the reception of the signal is detected; sampling on each delayed block; combining at least two sampled blocks; and tracking reception timing of the combined signal.

At this time, each block of the received signal is delayed through any one selected from the plurality of delay paths, and the tracking of the reception timing controls timing tracking granularity in consideration of the delay paths selected.

With the present invention, even though a low-speed sampling device is used, the same effect as with high-speed sampling can be obtained by inserting a unit adding a delay having a predetermined value in a reception process. In other words, since accurate timing information can be obtained using the sampling device having low complexity and low power consumption, an inexpensive and highly-integrated sampling device can be implemented.

### BRIEF DESCRIPTION OF THE DRAWINGS

FIG. 1 shows a structure of a data packet used in a communication system according toDeletedTextsan exemplary embodiment of the present invention;

FIG. 2 is a waveform diagram showing one example of a reference pulse used in an exemplary embodiment of the present invention;

FIG. 3 is a graph showing an effect of the clock offset on a distance measurement between the nodes;

FIG. 4 shows a principle of compensating for the clock offset by the timing tracker;

FIG. 5 is a block configuration diagram of a sampling device according to an exemplary embodiment of the present invention;

FIG. 6 shows a structure of a delayer according to an exemplary embodiment of the present invention;

FIG. 7 is a conceptual diagram showing a process of the packet delay for implementing the oversampling;

FIG. 8 is a conceptual diagram showing a principle where the accurate sampling is performed by the oversampling; and

FIG. 9 is a flow chart for explaining a principle of distance measurement between nodes in an asynchronous communication system.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, in addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

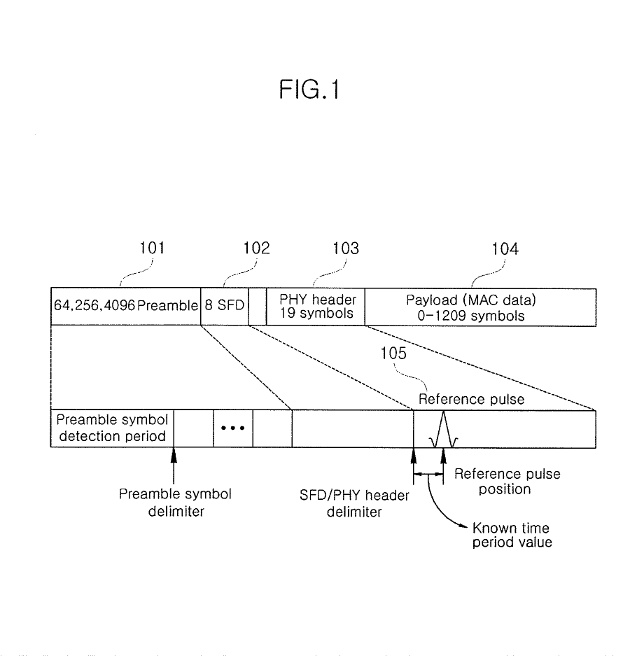

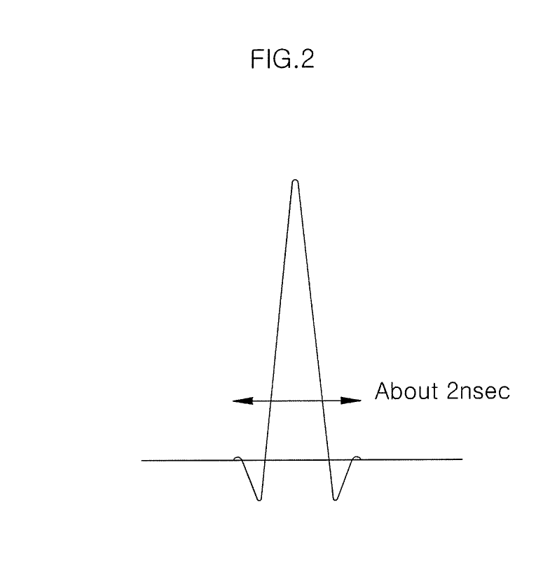

FIG. 1 shows a structure of a data packet according toDeletedTextsan exemplary embodiment of the present invention, and FIG. 2 is a waveform diagram showing one example of a reference pulse used in the exemplary embodiment.

Referring to FIG. 1, a data packet for impulse used in an exemplary embodiment of the present invention includes a preamble 101, a start frame delimiter 102, a physical layer header 103, and a payload 104.

A first pulse of the physical layer header 103 is referred to as a reference pulse 105.

As one example of a reference pulse 105, a pulse having a period of about 2 nsec can be used, as shown in FIG. 2.

Generally, in an asynchronous communication system, there is clock offset between a node of a transmitting end and a node of a receiving end.

Therefore, in FIG. 1, when the pulse generated according to a reference clock of node A of the transmitting end arrives at node B of the receiving end and then is sampled, mis-sampling occurs due to the offset of the reference clock, thereby making a distance measurement between the nodes inaccurate.

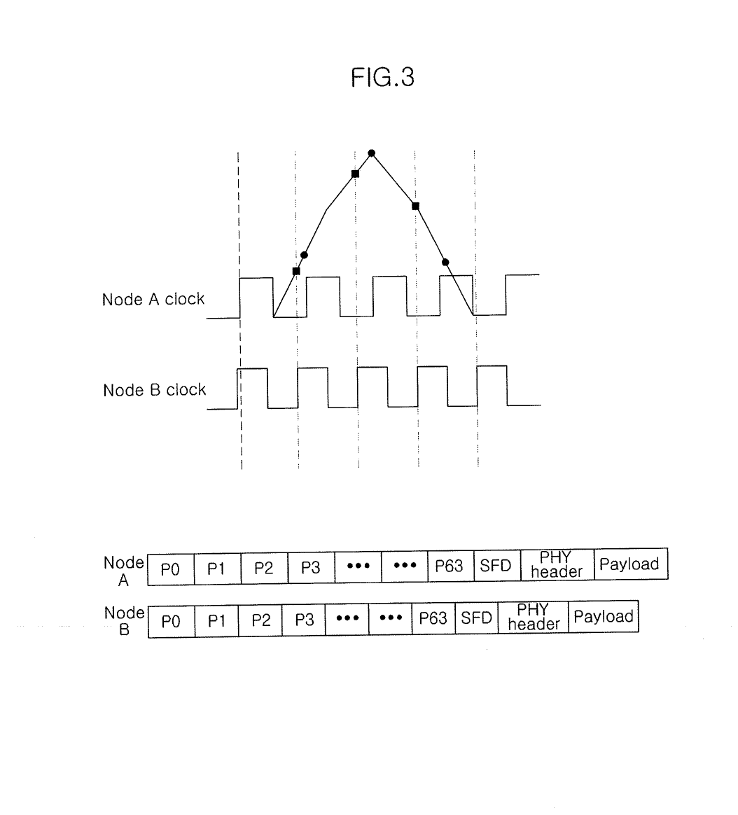

FIG. 3 is a graph showing an effect of the clock offset on a distance measurement between the nodes.

As shown in FIG. 3, since there is an offset between reference clocks of node A and node B, specific pulses transmitted from node A are not accurately sampled in node B.

When these results are applied to the entire packet, since a difference between time of transmitting the reference pulse 105 from the transmitting end and time of transmitting the reference pulse 105 to be received in the receiving end is continuously accumulated, an error upon measuring the distance is large if this is not compensated.

Therefore, the exemplary embodiment of the present invention disposes a timing tracker at node B, which is the receiving end, in order to correct the clock offset between the nodes.

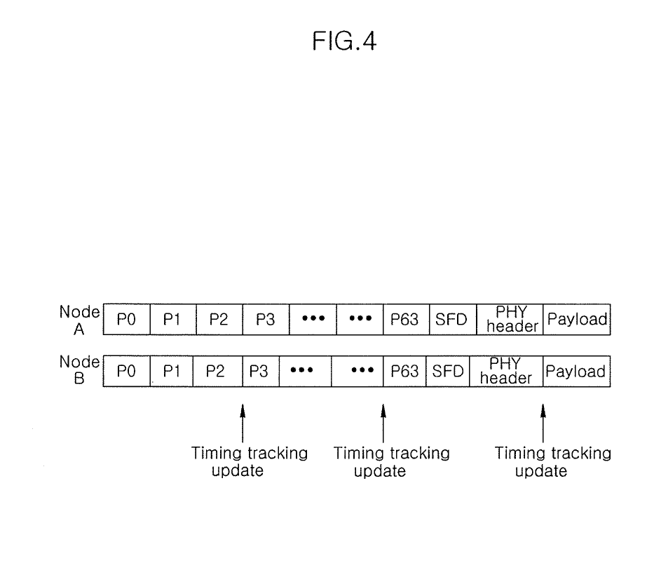

FIG. 4 shows a principle of compensating for the clock offset by the timing tracker.

If the reception of the packet is first detected, node B operates the timing tracker to lag or lead it at a predetermined timing.

In other words, as shown in FIG. 4, the timing error occurs at P1 and P2 among the packets transmitted by node A due to the clock offset, but whenever three packets are received, the timing tracker update is performed by the timing tracker to compensate for the timing error.

In this way, the clock offset between the transmitting end and the receiving end for the entire packets can be compensated.

Further, the exemplary embodiment of the present invention uniformly delays the received packets in a block unit and combines them to lead to the oversampling effect, thereby more accurately performing the correction of the clock offset.

A sampling device for performing this will be described below.

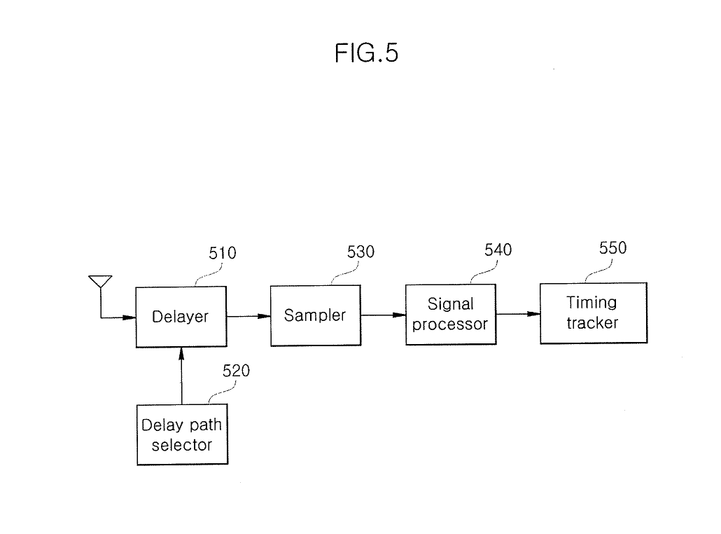

FIG. 5 is a schematic block diagram of a sampling device according to the exemplary embodiment of the present invention.

The sampling device according to theDeletedTextsexemplary embodiment of the present invention includes a delayer 510, a delay path selector 520, a sampler 530, a signal processor 540, and a timing tracker 550.

The delayer 510 delays the process of the received signal by a predetermined time.

To this end, the delayer 510 includes at least two selectable delay paths.

The delay path may be implemented by an analog path having predetermined delay values in a fixed form, and may be implemented to vary the delay values according to conditions through a combination of predetermined variable elements (for example, a combination of variable R/L/C) or a change of impedance.

In particular, in the former case, each of the delay paths is independently implemented with respect to all the predetermined delay values, and are implemented in a manner that disposes delay paths having the longest delay values at a predetermined interval and then connects delay paths having smaller delay values by a tab at the middle of the delay paths disposed at the predetermined interval.

The method of independently implementing the delay paths with respect to the predetermined delay values is a method that variously implements the signal paths by predetermined granularity and selects the signal paths according to predetermined control signals.

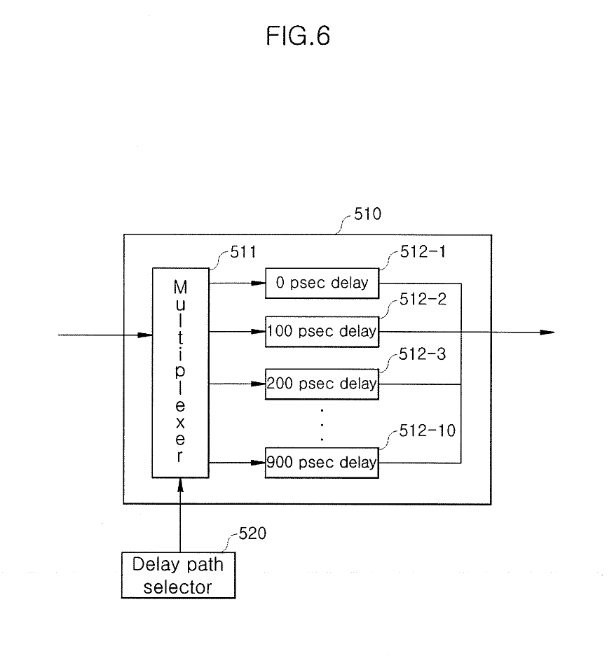

FIG. 6 shows a structure of the delayer according to the method.

In FIG. 6, the analog signal received through an antenna is input to any one of the plurality of paths, that is, 0 psec (512-1), 100 psec (512-2), 200 psec (512-3), . . . , 900 psec (512-10) via a multiplexer 511.

The plurality of delay paths implement signal paths corresponding to each delay values one by one. Or the plurality of delay paths implement the longest delay paths in a predetermined interval, and connect short delays at the middle of the longest delay paths by a tab.

Further, the plurality of delay paths can be implemented using a commercial delayer that has been already published in the art to which the exemplary embodiment of the present invention belongs and has been widely used.

The delay path selector 520 controls the multiplexer 511 in the delayer 510 to allow the delayer 510 to select any one of the delay paths.

The delay path selector 520 can control the delay path selection of the delayer 510 by using the predetermined selection pattern.

For example, when the delay paths supported by the delayer 510 are 0 psec, 100 psec, 200 psec, . . . , 700 psec, the delay path selector 520 arranges the control signals composed of 3 bits and can use them as the selection patterns.

In other words, when the control signals corresponding to 0 psec, 100 psec, 200 psec, . . . , 700 psec are “000”, “001”, “010”, . . . , “111”, the delay paths having 0 psec, 200 psec, 400 psec, and 600 psec are selected in a pattern of “000 010 100 110”.

However, the delay path selection patterns are previously set in the delay path selector 520 and do not depend on a separate external control Meanwhile, the delay path selector 520 can control the delay path selection of the delayer according to the external selection control signals.

In this case, the delay path selector 520 selects the delay path in real time according to the external selection control signals without the previously set selection patterns, or selects any one of the plurality of selection patterns previously saved in the delay path selector 520 according to the external selection control signals.

To perform N-times oversampling through the delay of the received signals, it is preferable that the delay path selector 520 transmits the path selection control signal at a position of a predetermined received signal block unit time to select a delay path having a delay value corresponding to the 1/N sampling period or an approximate value thereof.

The sampler 530 performs the sampling on the signals delayed by the delayer 510, and the signal processor 540 combines at least two sampling blocks that are sampled by the sampler 530.

The timing tracker 550 tracks the reception timing for the combined signals.

The timing tracker 550 controls the timing granularity in consideration of the delay paths selected by the delayer 510.

And, when N (N is an integer of 2 or more) sampling blocks are combined and oversampled, the timing tracker update is controlled to be performed in N sampling block units.

The preamble can be used as the sampling block.

At this time, after comparing the values for more oversampled positions by using the delay values as additional correction parameters, the timing tracker update can be performed in consideration of these comparison results.

A process where the sampling device described above uses the signal delay to derive the oversampling effect will be described, by way of example, in more detail below.

In a communication system where the preamble of the transmission signal is repeated, the sampling should be performed at a position where a maximum correlation peak is output. However, if the sampling rate is not sufficiently high, the position of the maximum peak cannot be known.

Therefore, in order to correct this, operation in a subsampling unit is needed.

If the signal path can be delayed to an extent where the size of the signal is not suddenly reduced, the operation in the subsampling unit can be performed using this.

For example, when the sampling is performed at a speed of 1 GHz, the first sampling operation starts at a position delayed by 500 ps and moves in units of 100ps before and after the position and shifts the delay value into a direction increasing the size of the delay value, thereby making it possible to obtain the optimal sampling.

If there is a repeated pattern in the received signal itself, the sampling is performed while the delay value varies by 500 ps.

Further, the two preamble periods are combined by using the characteristics of the repeated preamble, such that the sampling rate can be double.

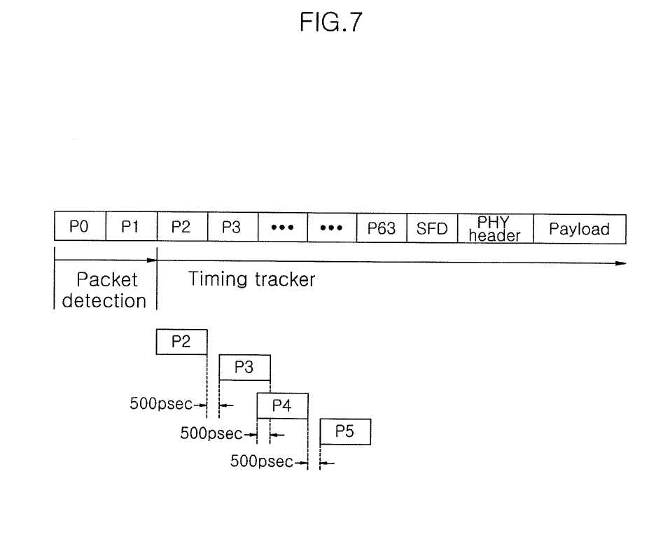

FIG. 7 is a conceptual diagram showing a process of the packet delay for implementing the oversampling.

In FIG. 7, assume that preambles P0 and P1 are used to detect the packet.

The delayer of the sampling device according to the exemplary embodiment of the present invention controls the delay from P2 to the fractional time of the sampling period.

In other words, the delayer applies the delay by a previously defined period (for example, sampling by 1 Gps but delayed by 500 psec) in the preamble unit according to a defined rule.

In order to implement 2-times oversampling, two preambles are used.

One preamble is sampled at a position of delay 0 and the other is sampled at a position of delay that is ½ of the sampling period.

In order to implement 3-times oversampling, three preambles are needed. Preamble 1 is delay 0, preamble 2 is sampled at a ⅓ sampling period delay position, and preamble 3 is sampled at a ⅔ sampling period delay position.

Generally, in order to implement N-times oversampling, N preambles are needed and a delay unit is determined as a 1/N sampling period.

The results obtained by the oversampling are applied to the timing tracker, making it possible to obtain more precise tracking results.

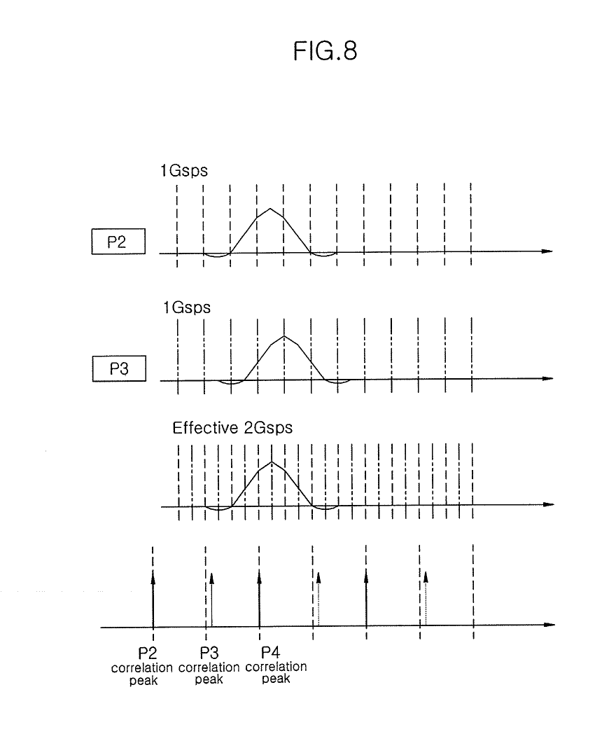

FIG. 8 is a conceptual diagram showing a principle where the accurate sampling is performed by the oversampling.

As shown in FIG. 8, a difference between a correlation value of P2 and a correlation value of P3 is a point having a difference of 500 psec or more as compared to a time difference to be generated when there is no oversampling, and when the sampling value at the corresponding point is applied to the timing tracker, the timing tracker update having the same resolution as that when double sampling value is obtained can be performed.

Even though the delay value to which the delay can be applied is not a fractional value of the accurately desired period, various algorithms can be designed considering the delay value at the use point in time by performing the delay using different values at a practical application point in time.

In other words, an effect of performing the high speed sampling can be obtained by any combination of delays.

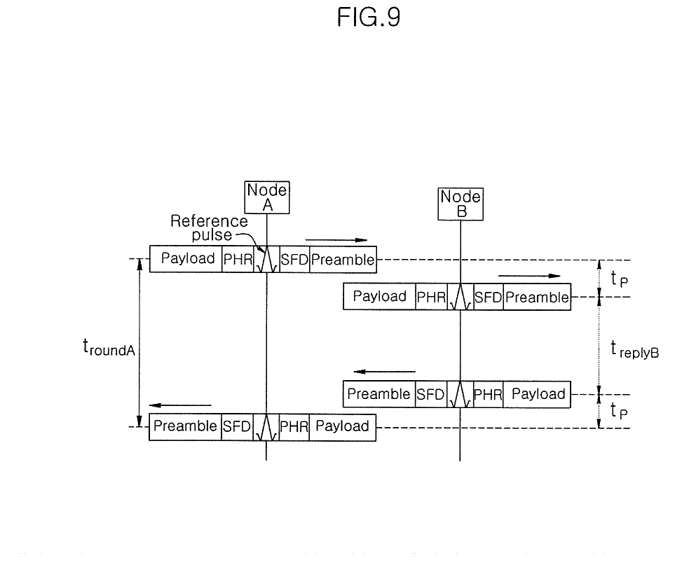

Assuming that the receiving time of the reference pulse 105 through the oversampling described above can be accurately measured, the distance between two nodes can be estimated by a method to be described below. FIG. 9 is a flow chart for explaining a principle of a distance measurement between nodes in an asynchronous communication system.

In FIG. 9, node A measures a time when the reference pulse 105 is transmitted to node B, a time when it is received in node B, a time when it is transmitted from node B to node A, and a time when it is received in node A, to obtain time of arrival (TOA).

TOA may be obtained according to the following Equation 1.

$${t}_{p} = \frac{{t}_{roundA} - {t}_{replyB}}{2} \qquad [ Equation 1 ]$$

Further, the distance d_{AB} between node A and node B is obtained according to the following Equation 2.

d_{AB}=c·tₚ [Equation 2]

where c indicates the speed of light.

The exemplary embodiments of the present invention are implemented not only through the apparatus and method, but may be implemented through a program that realizes functions corresponding to constituent members of the exemplary embodiments of the present invention or a recording medium in which the program is recorded. The implementation will be easily implemented by those skilled in the art as described in the exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A sampling device in a wireless communication system, comprising:
a delayer that delays received signals in a block unit;
a delay path selector that selects any one of a plurality of delay paths to control the delayer to apply the selected delay path to each block;
a sampler that performs sampling for each block delayed by the delayer;
a signal processor that combines at least two sampling blocks sampled by the sampler; and
a timing tracker that tracks reception timing of the combined signal.

2. The sampling device in a wireless communication system of claim 1, wherein each of the plurality of delay paths is independently implemented with respect to predetermined delay values.

3. The sampling device in a wireless communication system of claim 1, wherein the plurality of delay paths are implemented in a manner that disposes delay paths having the longest delay values at a predetermined interval and then connects delay paths having smaller delay values by a tab at the middle of the delay paths disposed at the predetermined interval.

4. The sampling device in a wireless communication system of claim 1, wherein the delay path selector uses a predetermined selection pattern to control the delay path selection of the delayer.

5. The sampling device in a wireless communication system of claim 1, wherein the delay path selector controls the delay path selection of the delayer according to external selection control signals.

6. The sampling device in a wireless communication system of claim 1, wherein the timing tracker controls timing tracking granularity in consideration of the delay paths selected by the delayer.

7. The sampling device in a wireless communication system of claim 6, wherein the timing tracker controls to perform timing tracking update in the combined sampling block unit when oversampling is performed by a sampling combination of the signal processor.

8. The sampling device in a wireless communication system of claim 6, wherein the timing tracker determines a performance position of the timing tracking update by comparing generation positions of oversampling by using the delay values of the delayer as correction parameters when the oversampling is performed by the sampling combination of the signal processor.

9. The sampling device in a wireless communication system of claim 1, wherein the signal processor performs N-times oversampling while combining the sampling block, and the delay path selector controls the delayer to select the delay paths having delay values closest to a 1/N sampling period when the N-times oversampling is performed.

10. A sampling method in a wireless communication system of allowing a receiver to sample signals, comprising:
delaying the received signal in a block unit when the reception of the signal is detected;
sampling on each delayed block, combining at least two sampled blocks; and
tracking reception timing of the combined signal.

11. The sampling method in a wireless communication system of claim 10, wherein each block of the received signal is delayed through any one delay path selected from the plurality of delay paths.

12. The sampling method in a wireless communication system of claim 11, wherein the tracking of the reception timing controls timing tracking granularity in consideration of the delay paths selected.
